(19) United States
(12) Patent Application Publication
(10) Pub. No.: US 2026/0269869 A1
(43) Pub. Date: Sep. 10, 2026

(54) COORDINATED MULTI-ACCESS POINT TRIGGER FRAME EXTENSION SCHEMES

(71) Applicant: MEDIATEK INC., Hsinchu City (TW)

(72) Inventors: Shuling FENG, San Jose, CA (US); Jianhan LIU, San Jose, CA (US); Hung-Tao HSIEH, Hsinchu City (TW); Kai Ying LU, San Jose, CA (US)

(21) Appl. No.: 19/166,283

(22) PCT Filed: Jun. 7, 2024
(86) PCT No.: PCT/CN2024/098194

§ 371 Date: Sep. 17, 2025

Related U.S. Application Data
(60) Provisional application No. 63/510,926, filed on Jun. 29, 2023.

(51) Int. Cl. H04B 7/024; H04B 7/06; H04W 74/06; H04W 84/12

(52) U.S. Cl. CPC H04B 7/024; H04B 7/0617; H04W 74/06; H04W 84/12

(57) ABSTRACT

Various techniques pertaining to coordinated multi-access point (CMAP) trigger frame (TF) extension schemes in wireless communications are described. An apparatus (e.g., an access point (AP)) transmits or receives a trigger frame (TF) that triggers a coordinated beamforming (CBF) transmission. The apparatus then participates in the CBF transmission. The TF provides an extension of time allowing each of one or more shared APs to finish recalculation of one or more steering matrixes for the CBF transmission before participating in the CBF transmission.

### CROSS REFERENCE TO RELATED PATENT APPLICATION

The present disclosure is part of a non-provisional patent application claiming the priority benefit of U.S. Provisional Patent Application No. 63/510,926, filed 29 Jun. 2023, the content of which herein being incorporated by reference in its entirety.

### TECHNICAL FIELD

The present disclosure is generally related to wireless communications and, more particularly, to coordinated multi-access point (CMAP) trigger frame (TF) extension schemes in wireless communications.

### BACKGROUND

Unless otherwise indicated herein, approaches described in this section are not prior art to the claims listed below and are not admitted as prior art by inclusion in this section.

In wireless communications such as WiFi (or Wi-Fi) and WLANs under the Institute of Electrical and Electronics Engineers (IEEE) 802.11 specifications, coordinated transmission beamforming (herein interchangeably referred to as “coordinated TxBF” and “CBF”) transmissions are proposed for Ultra High Reliability (UHR) in next-generation WLAN. CBF is intended to allow multiple access points (APs) to transmit to multiple stations (STAs) simultaneously on the same frequency band. Given adequate antenna resources, each AP beamforms its transmission power toward its own targeted STAs and nulls transmission power at STAs served by other CBF APs. CBF transmissions improve overall network throughput by mitigating interference powers that STAs receive from APs other than their associated AP. However, at the time of invention as described in the present disclosure, further enhancement to trigger frames (TFs) to support CBF needs to be specified. Therefore, there is a need for a solution of CMAP TF extension schemes in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to CMAP TF extension schemes in wireless communications. It is believed that various schemes proposed herein may address or otherwise alleviate the aforementioned issue(s). It is noteworthy that the proposed schemes described herein may be applied to CMAP scenarios, although not limited to the context of CBF. Moreover, the proposed schemes may be applied to lightly coordinated beamforming (LCBF), such as asynchronous CBF (A-CBF), MAP scenarios.

In one aspect, a method may involve a processor of a sharing AP transmitting a trigger frame to one or more shared APs to trigger a CBF transmission. The method may also involve the processor participating in the CBF transmission with the one or more shared APs. The trigger frame may provide an extension of time allowing each of the one or more shared APs to finish recalculation of one or more steering matrixes for the CBF transmission before participating in the CBF transmission.

In another aspect, a method may involve a processor of a shared AP receiving a trigger frame from a sharing AP that triggers a CBF transmission. The method may also involve the processor participating in the CBF transmission with the sharing AP. The trigger frame may provide an extension of time allowing the shared AP to finish recalculation of one or more steering matrixes for the CBF transmission before participating in the CBF transmission.

In yet another aspect, an apparatus may include a transceiver configured to communicate wirelessly and a processor coupled to the transceiver. The processor may transmit or receive a trigger frame that triggers a CBF transmission. The processor may also participate in the CBF transmission. The trigger frame may provide an extension of time allowing each of one or more shared APs to finish recalculation of one or more steering matrixes for the CBF transmission before participating in the CBF transmission.

It is noteworthy that, although description provided herein may be in the context of certain radio access technologies, networks and network topologies such as, WiFi/WLAN, the proposed concepts, schemes and any variation(s)/derivative(s) thereof may be implemented in, for and by other types of radio access technologies, networks and network topologies such as, for example and without limitation, Bluetooth, ZigBee, 5th Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario in accordance with an implementation of the present disclosure.

FIG. 3 is a diagram of an example scenario in accordance with an implementation of the present disclosure.

FIG. 4 is a diagram of an example design in accordance with an implementation of the present disclosure.

FIG. 5 is a diagram of an example design in accordance with an implementation of the present disclosure.

FIG. 6 is a diagram of an example design in accordance with an implementation of the present disclosure.

FIG. 7 is a diagram of an example design in accordance with an implementation of the present disclosure.

FIG. 8 is a block diagram of an example communication system in accordance with an implementation of the present disclosure.

FIG. 9 is a flowchart of an example process in accordance with an implementation of the present disclosure.

FIG. 10 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to CMAP TF extension schemes in wireless communications. According to the present disclosure, a number of possible solutions may be implemented separately or jointly. That is, although these possible solutions may be described below separately, two or more of these possible solutions may be implemented in one combination or another.

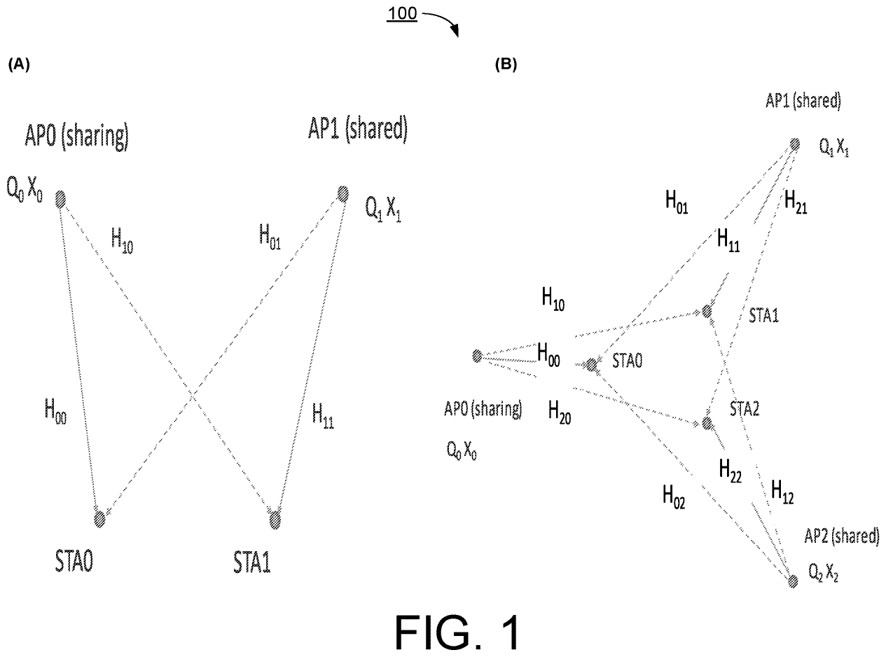

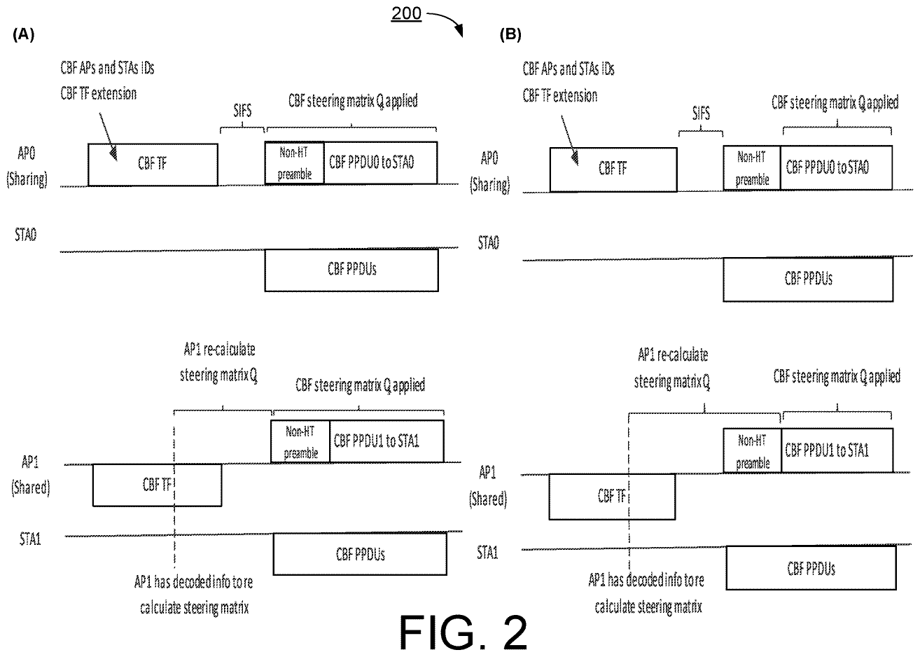

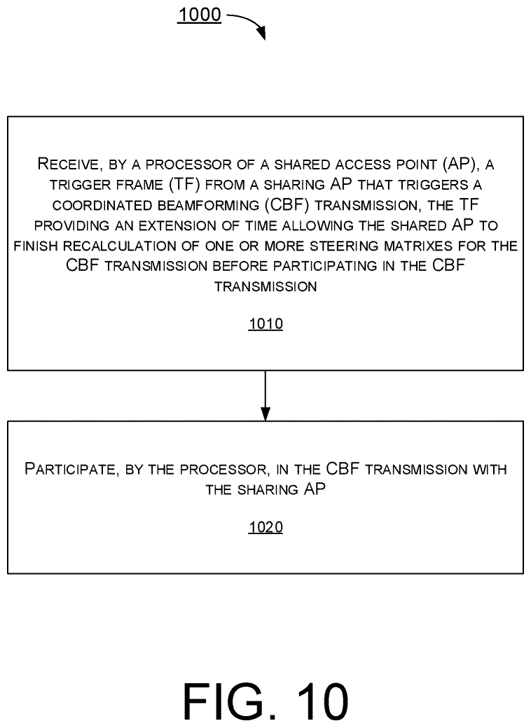

FIG. 1 illustrates an example network environment 100 in which various solutions and schemes in accordance with the present disclosure may be implemented. FIG. 2~FIG. 10 illustrate examples of implementation of various proposed schemes in network environment 100 in accordance with the present disclosure. The following description of various proposed schemes is provided with reference to FIG. 1~FIG. 10.

Network environment 100 may involve multiple APs (e.g., AP0, AP1, AP2) communicating wirelessly with multiple STAs (e.g., STA0, STA1, STA2). Each AP (herein interchangeably referred to as “AP STA”) and each STA (herein interchangeably referred to as “non-AP STA”) may be configured to communicate with each other by utilizing the various proposed schemes described below. For instance, each of AP0, AP1, AP2, STA0, STA1 and STA2 may be configured to perform wireless communications with CMAP TF extension schemes under various proposed schemes as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

In a CBF scenario in next generation WLAN, a first AP (e.g., AP0) may be a sharing AP (also known as a main AP (MP)) while each of other APs (e.g., AP1 and AP2) may be a shared AP (also known as an auxiliary AP (AAP)) participating in CBF transmissions. In network environment 100, each AP may transmit beamformed data to its targeted STA(s) during CBF transmissions while nulling its transmission power at other STAs targeted by other CBF-participating APs. For simplicity, each of the APs 20 in FIG. 1 is shown to be in communication with and serving one respective STA (e.g., AP0 serving STA0 or AP0→STA0, AP1 serving STA1 or AP1→STA1, AP2 serving STA2 or AP2→STA2) although each AP may serve and transmit data to multiple users/STAs simultaneously. Part (A) of FIG. 1 shows an example of CBF between two APs, with AP0 being the sharing AP (and having STA0 as its associated STA) and AP1 being the shared AP (and having STA1 as its associated STA). Part (B) of FIG. 1 shows an example of CBF among three APs, with AP0 being the sharing AP (and having STA0 as its associated STA) and AP1 and AP2 being the shared APs (and having STA1 and STA2 as their associated STAs, respectively). In each of part (A) and part (B) of FIG. 1, a solid line between a serving AP and its served STA represents the transmission power from the serving AP to the served STA (e.g., the solid line between AP0 and STA0 representing the transmission power from AP0 to STA0, the solid line between AP1 and STA1 representing the transmission power from AP1 to STA1, and so on). Moreover, in each of part (A) and part (B) of FIG. 1, a dotted line between an AP and a STA represents the nulling direction between the AP and that STA (e.g., the dotted line between AP0 and STA1, the dotted line between AP1 and STA0, and so on). That is, in the CMAP/CBF context, the transmission power of a given AP in the nulling direction is nulled, canceled or otherwise significantly lowered, thereby minimizing interference on a STA that is not served by that AP.

There may be some assumptions for CBF transmissions. For instance, it may be assumed that there are already schemes for each AP to obtain the channel state information (CSI) from each STA participating in the coordinated TxBF transmissions. In the example shown in part (A) of FIG. 1, H₀₀ represents CSI from AP0 to STA0 and H₁₀ represents CSI from AP0 to STA1, H₀₁ represents CSI from AP1 to STA0, and H₁₁ represents CSI from AP1 to STA1. It may be assumed that AP0 obtained H₀₀ and H₁₀, and AP1 obtained H₀₁ and H₁₁. In the example shown in part (B) of FIG. 1, H₀₀ represents CSI from AP0 to STA0, H₁₀ represents CSI from AP0 to STA1, H₂₀ represents CSI from AP0 to STA2, H₀₁ represents CSI from AP1 to STA0, H₁₁ represents CSI from AP1 to STA1, H₂₁ represents CSI from AP1 to STA2, H₀₂ represents CSI from AP2 to STA0, H₁₂ represents CSI from AP2 to STA1, and H₂₂ represents CSI from AP2 to STA2. It may be assumed that AP0 obtained H₀₀, H₁₀ and H₂₀, AP1 obtained H₀₁, H₁₁ and H₂₁, and AP2 obtained H₀₂, H₁₂ and H₂₂. The CSI may be obtained in implicit or explicit soundings, assuming the wireless channels are quasi-static and the CSIs are up to date for CBF transmission.

It may also be assumed that the sharing AP already obtained, from participating shared APs, the identifications (IDs) of CBF-participating STAs, the IDs of their serving APs and their data buffer status. It may additionally be assumed that the sharing AP has obtained a transmission opportunity (TXOP) and has decided to share the TXOP with shared APs with CBF transmissions to a group of selected STAs on the full bandwidth or a certain part of the bandwidth.

It may be further assumed that each CBF-participating AP has enough antenna resources to null its transmission fully or partially to STAs targeted by other CBF-participating APs. The sharing AP and shared APs may update (e.g., recalculate) their steering matrixes for CBF transmissions. For the example in part (A) of FIG. 1, AP0 may apply steering matrix Q₀ (updated/recalculated for CBF) in transmitting data to STA0 (represented by X₀ in FIG. 1) and may null its transmission power in the null space of H₁₀ to mitigate its interference to STA1. Moreover, AP1 may update/recalculate steering matrix Q₁ in transmitting data to STA1 (represented by X₁ in FIG. 1) and may null its transmission power in the null space of H₀₁ to mitigate interference to STA0. For the example in part (B) of FIG. 1, AP0 may apply steering matrix Q₀ in transmitting data to STA0 (represented by X₀ in FIG. 1) and may null its transmission power in the null space of H₁₀ and H₂₀ to mitigate its interference to STA1 and STA2, respectively, AP1 may apply steering matrix Q₁ in transmitting data to STA1 (represented by X₁ in FIG. 1) and may null its transmission power in the null space of H₀₁ and H₂₁ to mitigate interference to STA0 and STA2, respectively, and AP2 may apply steering matrix Q₂ in transmitting data to STA2 (represented by X₂ in FIG. 1) and may null its transmission power in the null space of H₀₂ and H₁₂ to mitigate interference to STA0 and STA1, respectively.

Under a proposed scheme in accordance with the present disclosure, based on the above assumptions, the sharing AP may send a CBF trigger frame (TF) to the shared APs to trigger CBF transmissions. Certain information may be contained in the CBF TF. For instance, information included in the CBF TF may include: the ID of the sharing AP, the IDs of STAs to which the sharing AP will transmit in a CBF frame short interframe space (SIFS) after the TF, the IDs of the shared APs, and the IDs of STAs to which the shared APs will transmit in the CBF frame SIFS after the TF. Under the proposed scheme, the CBF TF may be a new type of trigger frame or, alternatively, modified from an existing TF type to carry the aforementioned information as well as to indicate an extension of CBF TF. The shared APs may decode the CBF TF and recalculate steering matrixes based on the decoded IDs of APs and STAs participating in the CBF transmissions in order to mitigate interference. In the example shown in part (A) of FIG. 1, AP1 may recalculate steering matrix Q₁ and apply it on its CBF transmission. In the example shown in part (B) of FIG. 1, AP1 may recalculate steering matrix Q₁ and apply it on its CBF transmission, and AP2 may recalculate steering matrix Q₂ and apply it on its CBF transmission.

FIG. 2 illustrates an example scenario 200 of CBF TF and CBF physical-layer protocol data unit (PPDU) transmissions for two APs under a proposed scheme in accordance with the present disclosure. In scenario 200, the sharing AP may transmit a trigger frame of the CBF TF type to trigger a CBF transmission among CBF-participating APs. The CBF TF may include the IDs of participating APs and STAs. Correspondingly, the shared AP may start recalculation of its steering matrix once it decodes the necessary information from the received CBF TF. The shared AP does not need to wait until the end of the decoding of CBF TF to start recalculating the steering matrix. The recalculation of steering matrixes by shared APs may take several tens of microseconds (μs) depending on specific AP vendor's implementation. In some cases, as shown in part (A) of FIG. 2, CBF-participating APs may apply CBF TxBF on non-high-throughput (non-HT) preambles. Based on the current IEEE 802.11ax and 802.11be specifications, the time that a shared AP is allowed to use to recalculate steering matrixes may be much shorter than it needs. In some cases, as shown in part (B) of FIG. 2, CBF-participating APs may not apply CBF TxBF on non-HT preambles. The time that a shared AP is allowed to use to recalculate steering matrixes may still be shorter than it needs. Under the proposed scheme, a CBF TF extension may be utilized (under Scheme 1 and Scheme 2 described below) to guarantee that the shared APs can have sufficient time to recalculate steering matrixes for CBF TF. Both Scheme 1 and Scheme 2 may only be applied for CBF-participating APs to extend the length of a CBF TF. Under the proposed scheme, the definition of trigger frame medium access control (MAC) padding duration and padding processing, as defined in IEEE 802.11ax, may be expanded from non-AP STAs to APs. There may be no change from existing IEEE specifications on the definition of trigger frame MAC padding duration and padding processing for non-AP STAs.

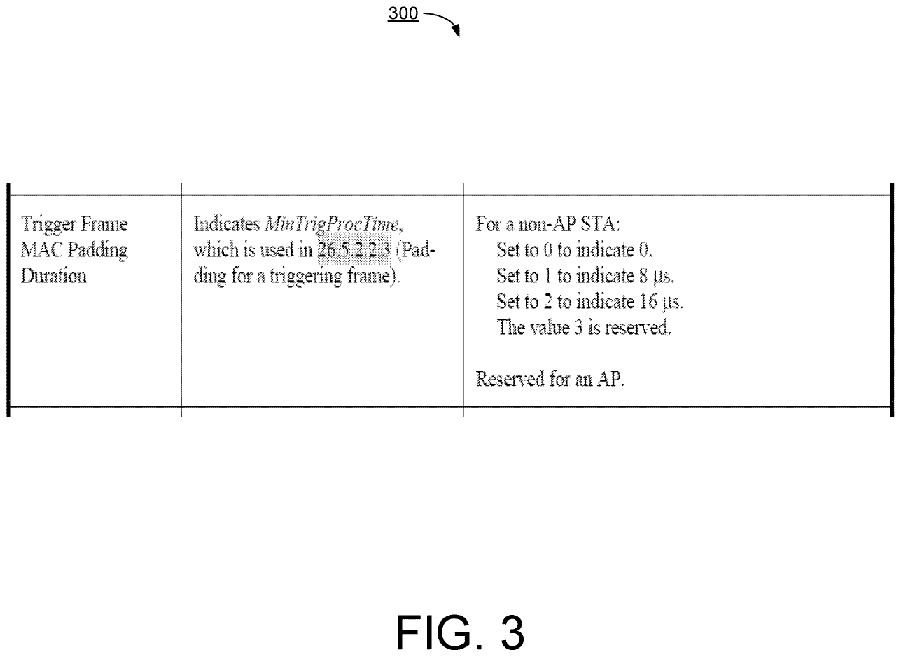

FIG. 3 illustrates an example scenario 300 of TF extension. According to the IEEE 802.11ax standard, an optional pre-forward error correction (pre-FEC) padding in a TF may be allowed to extend the packet length so as to provide recipient STA(s) sufficient time to prepare a response for transmission a SIFS after the frame is received. The Padding field, if present, is at least two octets in length and is set to all 1's. In case that the Padding field is present in a TF, its length is computed as described in Section 26.5.2.2.3 (Padding for a triggering frame) of the IEEE 802.11ax specification. An AP may use any type of padding to satisfy the minimum trigger frame processing time (MinTrigProcTime) requirement of a non-AP STA, such as using the Padding field in a Trigger frame, post-end of field (post-EOF) aggregate MAC protocol data unit (A-MPDU) padding or aggregating other MPDUs in the A-MPDU. The calculation of the number of padded bits, L_{PAD,MAC}, for binary convolutional coding (BCC) coded TF and a trigger frame processing time, T_{TrigProc}, for low-density parity-check (LDPC) coded TF are based on the largest MinTrigProcTime of all associated non-AP STAs. Under the proposed scheme, STAs may use a subfield of “Trigger Frame MAC Padding Duration” in a high-efficiency (HE) MAC Capabilities Information field to indicate a 0, 8 or 16 μs trigger frame MAC processing duration, as shown in FIG. 3.

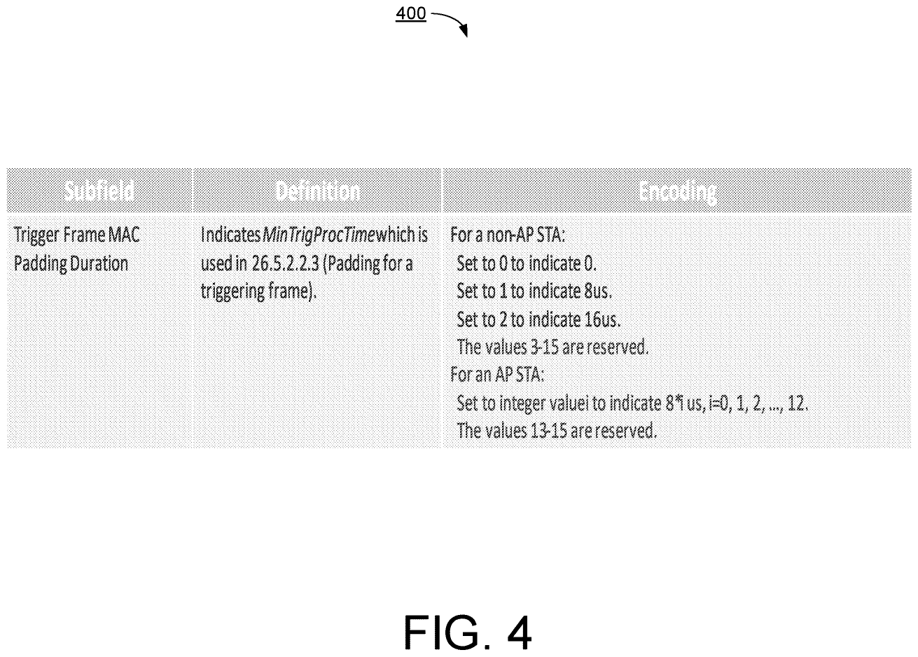

FIG. 4 illustrates an example scenario 400 of CBF TF extension (Scheme 1) under a proposed scheme in accordance with the present disclosure. In Scheme 1, the definition of an existing subfield, the “Trigger Frame MAC Padding Duration” subfield, in the MAC Capabilities Information field may be modified or otherwise expanded for shared APs to use for CBF transmissions. For instance, the subfield “Trigger Frame MAC Padding Duration” may be expanded from 2 bits to 4 bits. As shown in the “Encoding” section of the table in FIG. 4, the duration for matrix recalculation may be extended by 8*i microseconds, from 0 μs to 96 μs (with i=0, 1, 2, . . . , 12). Moreover, Table 9-332a-Subfields of the HE MAC Capabilities Information field (continued) in the IEEE 802.11ax specification may be expanded by replacing the entry “Trigger Frame MAC Padding Duration” with that shown in FIG. 4. Under the proposed scheme, the shared APs may start recalculation of steering matrixes once they have decoded the TF type, the IDs of CBF-participating APs and STAs, and so on. The shared APs do not need to wait until the end of decoding CBF TF to start recalculation of steering matrixes.

In Scheme 1, either Option A or Option B may be utilized to extend the CBF TF based on the largest MinTrigProcTime of all shared APs participating in following CBF transmissions. Under Option A in Scheme 1, the sharing AP may use any type of padding to satisfy the MinTrigProcTime requirement of a shared AP participating in CBF transmissions. For instance, the sharing AP may use the Padding field in a Trigger frame, post-EOF A-MPDU padding or aggregating other MPDUs in the A-MPDU. When using the Padding field in the CBF TF, the sharing AP may pad this TF following similar rules described in Section 26.5.2.2.3 (Padding for a triggering frame) in the IEEE 802.11ax specification. The sharing AP may calculate the number of padded bits, L_{PAD,MAC}, for BCC coded CBF TF and trigger frame processing time, T_{TrigProc}, for LDPC coded CBF TF based on the largest MinTrigProcTime of all shared APs participating in the following CBF transmissions.

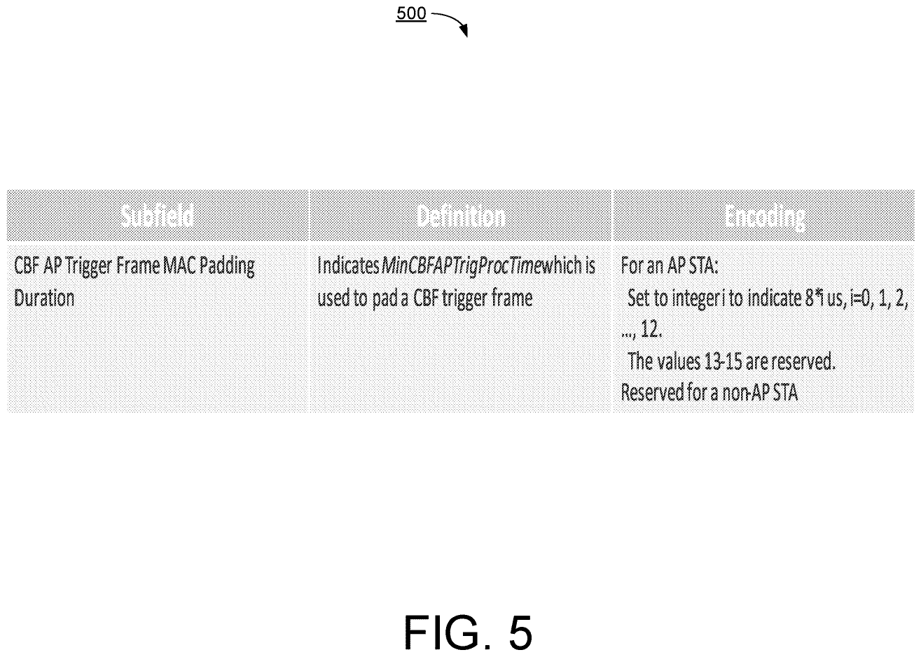

FIG. 5 illustrates an example scenario 500 of CBF TF extension (Scheme 2) under a proposed scheme in accordance with the present disclosure. In Scheme 2, a new subfield, “CBF AP Trigger Frame MAC Padding Duration” subfield, may be added in the MAC Capabilities Information field for shared APs to use for CBF transmissions. For instance, Table 9-332a—Subfields of the HE MAC Capabilities Information field (continued) in the IEEE 802.11ax specification may be expanded by adding an entry “CBF AP Trigger Frame MAC Padding Duration” as shown in FIG. 5. Under the proposed scheme, the shared APs may start recalculation of steering matrixes once they have decoded the TF type, the IDs of CBF-participating APs and STAs, and so on. The shared APs do not need to wait until the end of decoding CBF TF to start recalculation of steering matrixes. As shown in the “Encoding” section of the table in FIG. 5, the duration for matrix recalculation may be extended by 8*i microseconds, from 0 μs to 96 μs (with i=0, 1, 2, . . . , 12).

In Scheme 2, either Option A or Option B may be utilized to extend the CBF TF based on the largest minimum CBF AP trigger processing time (MinCBFAPTrigProcTime) of all shared APs participating in the following CBF transmissions. Under Option A in Scheme 2, the sharing AP may use any type of padding to satisfy the MinCBFAPTrigProcTime requirement of a shared AP participating in CBF transmissions. For instance, the sharing AP may use the Padding field in a Trigger frame, post-EOF A-MPDU padding or aggregating other MPDUs in the A-MPDU. When using the Padding field in the CBF TF, the sharing AP may pad this TF following similar rules described in Section 26.5.2.2.3 (Padding for a triggering frame) in the IEEE 802.11ax specification. The sharing AP may calculate the number of padded bits, L_{PAD,MAC}, for BCC coded CBF TF and trigger frame processing time, T_{TrigProc}, for LDPC coded CBF TF based on the largest MinCBFAPTrigProcTime of all shared APs participating in the following CBF transmissions. The sharing AP may replace MinTrigProcTime with MinCBFAPTrigProcTime to calculate TF extension and apply padding.

Under Option B in both Scheme 1 and Scheme 2, a CBF TF may be extended by an AP by adding extra symbols to the end of packet. Under the proposed schemes, the sharing AP may extend the CBF TF by adding extra symbols to the end of a packet. In Scheme 1, the MinTrigProcTime may be redefined for CBF-participating APs. The sharing AP may calculate the number of symbols, N_{symTFext}, added to the end of CBF TF based on the largest MinTrigProcTime of all shared APs participating in the following CBF transmissions. In Scheme 2, the MinCBFAPTrigProcTime may be defined for CBF-participating APs. The sharing Ap may calculate the number of symbols, N_{symTFext}, added to the end of CBF TF based on the largest MinCBFAPTrigProcTime of all shared APs participating in the following CBF transmissions. It is noteworthy that adding extra symbols does not affect the timing of decoding the TF, thereby extending the CBF steering matrix processing time of shared APs. The number of added symbols, N_{symTFext}, may be signaled in the CBF TF. Under the proposed schemes, the CBF TF extension time, T_{TFext}, may be included in CBF TF legacy signal (L-SIG) packet length calculation by extending the transmission time (TXTIME). In the equations below, the packet extension (PE) time, T_{PE}, may be replaced with T_{TFext}+T_{PE} when the transmission time is calculated by the equations below.

$$TXTIME = 20 + {T}_{HE - PREAMBLE} + {N}_{SYM} {T}_{SYM} + {N}_{MA} {N}_{HE - LTF} {T}_{HE - LTF - SYM} + {T}_{PE} + SignalExtension$$

$$Length = ⌈ \frac{TXTIME - SignalExtension - 20}{4} ⌉ \times 3 - 3 - m$$

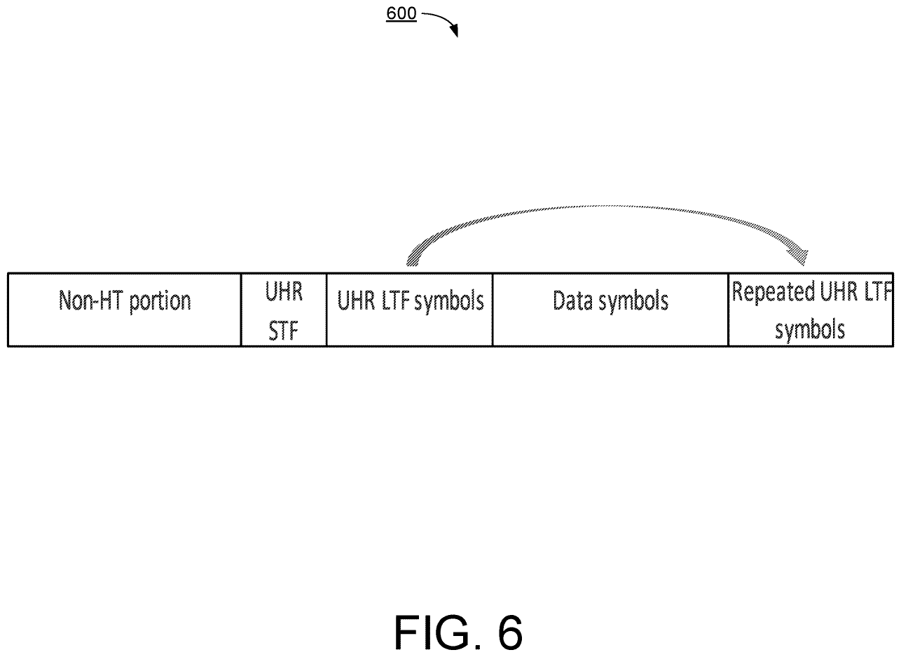

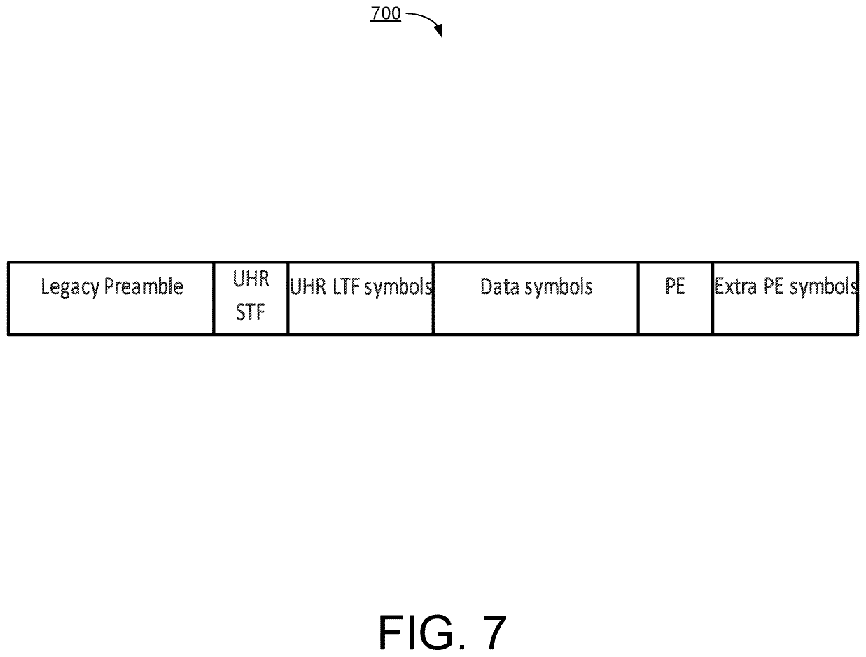

It is noteworthy that, when a trigger frame is of the type CBF TF, the TF also includes indications of the number of extra symbols padded to the end of the CBF TF. Accordingly, two variations in Option B may be utilized to extend CBF TF by appending extra symbols to the end of the packet at the physical-layer (PHY) level. FIG. 6 illustrates an example scenario 600 under a first variation of Option B (CBF TF extension Option B1). FIG. 7 illustrates an example scenario 700 under a second variation of Option B (CBF TF extension Option B2). As shown in FIG. 6, the extra symbols may be repetitions of long-training field (LTF) symbols used to decode data symbols. They may be used to refine synchronization between the sharing AP and shared APs. That is, under CBF TF extension Option B1, repeated LTF symbols may be added to the end of a CBF TF. As shown in FIG. 7, the extra symbols may be extra PE symbols similar to the PE symbol defined in Section 27.3.13 (Packet extension) in the IEEE 802.11ax specification. That is, under CBF TF extension Option B2, extra PE symbols may be added to the end of the CBF TF.

Under CBF TF extension Option B1, the padding length (L_{pad}) may be determined by the sharing AP based on the largest MinTrigProcTime or MinCBFAPTrigProcTime of all shared APs participating in the following CBF transmissions. The number of long-training field (for example, UHR-LTF) symbols padded to the end of CBF TF may be calculated as follows:

$${N}_{symTFext} = ⌈ \frac{{L}_{pad}}{{T}_{symLTF}} ⌉$$

Here, T_{symLTF} denotes the time duration for each of n UHR-LTF symbols, and it may have a value of 4, 8 or 16 μs. Under CBF TF extension Option B1, the following UHR-LTF symbols may be padded to the end of the CBF TF:

$${{k}_{0}}^{*} UHR - {LTF}_{0} , {{k}_{1}}^{*} UHR - {LTF}_{1} , … {{k}_{n - 1}}^{*} UHR - {LTF}_{n - 1} , {{k}_{n}}^{*} UHR - {LTF}_{0} , {{k}_{n + 1}}^{*} UHR - {LTF}_{1} , … , {{k}_{NsymTFext - 1}}^{*} UHR - {LTF}_{m}$$

Here, n denotes the number of UHR-LTF symbols; kᵢ denotes a predefined constant for the i^{th} appended LTF symbol; and m may have a value of 0, 1, . . . or n−1, and m may be calculated as m=(N_{symTFext}−1) % n. The CBF TF extension time, T_{TFext}, used to calculate the length in L-SIG under Option B may be T_{TFext}=T_{symLTF}. N_{symTFext}. Moreover, T_{PE} may be replaced with T_{TFext}+T_{PE} when TXTIME is calculated. For instance, given four 4×UHR LTF symbols (UHR-LTF0~UHR-LTF3) in the UHR LTF Symbol field, each with 16 μs symbol duration (e.g., T_{symLTF}=16 μs). In a first example (Case 1), with padding length L_{pad}=48 us and N_{symTFext}=3, the sharing AP may append k₀*UHR-LTF₀, k₁*UHR-LTF₁, k₂*UHR-LTF₂ to the end of CBF TF frame, and T_{TFext}=48 μs. In a second example (Case 2), with padding length L_{pad}=56 μs and N_{symTFext}=4, the sharing AP may append k₀*UHR-LTF₀, k₁*UHR-LTF₁, k₂*UHR-LTF₂, k₃*UHR-LTF₃ to the end of CBF TF frame, and T_{TFext}=64 μs. In a third example (Case 3), with padding length L_{pad}=64 μs and N_{symTFext}=4, the sharing AP may append k₀*UHR-LTF₀, k₁*UHR-LTF₁, k₂*UHR-LTF₂, k₃*UHR-LTF₃ to the end of CBF TF frame, and T_{TFext}=64 μs. In a fourth example (Case 4), with padding length L_{pad}=72 μs and N_{symTFext}=5, the sharing AP may append k₀*UHR-LTF₀, k₁*UHR-LTF₁, k₂*UHR-LTF₂, k₃*UHR-LTF₃, k₄*UHR-LTF₀ to the end of CBF TF frame, and T_{TFext}=80 μs.

Under CBF TF extension Option B2, the padding length (L_{pad}) may be determined by the sharing AP based on the largest MinTrigProcTime or MinCBFAPTrigProcTime of all shared APs participating in the following CBF transmissions. Extra PE symbols may be added to the end of CBF TF after the existing PE symbol, if present. The time duration of each extra PE symbol, T_{symPE}, may be 4, 8 or 16 μs. The number of extra PE symbols added may be calculated as follows:

$${N}_{symTFext} = ⌈ \frac{{L}_{pad}}{{T}_{symPE}} ⌉$$

The CBF TF extension time, T_{TFext}, used to calculate the length in L-SIG may be T_{TFext}=T_{symPE}. N_{symTFext}. The packet extension time, T_{PE}, may be replaced with T_{TFext}+T_{PE} when the transmission time is calculated.

### Illustrative Implementations

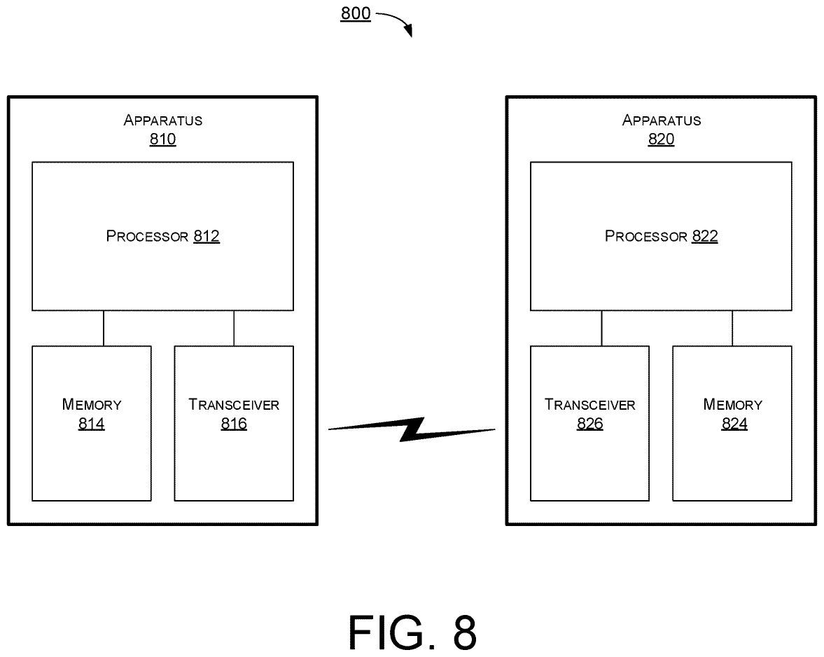

FIG. 8 illustrates an example system 800 having at least an example apparatus 810 and an example apparatus 820 in accordance with an implementation of the present disclosure. Each of apparatus 810 and apparatus 820 may perform various functions to implement schemes, techniques, processes and methods described herein pertaining to CMAP TF extension schemes in wireless communications, including the various schemes described above with respect to various proposed designs, concepts, schemes, systems and methods described above as well as processes described below. For instance, apparatus 810 may be implemented in STA 110 and apparatus 820 may be implemented in STA 120, or vice versa.

Each of apparatus 810 and apparatus 820 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 810 and apparatus 820 may be implemented in a smartphone, a smart watch, a personal digital assistant, a digital camera, or a computing equipment such as a tablet computer, a laptop computer or a notebook computer. Each of apparatus 810 and apparatus 820 may also be a part of a machine type apparatus, which may be an IoT apparatus such as an immobile or a stationary apparatus, a home apparatus, a wire communication apparatus or a computing apparatus. For instance, each of apparatus 810 and apparatus 820 may be implemented in a smart thermostat, a smart fridge, a smart door lock, a wireless speaker or a home control center. When implemented in or as a network apparatus, apparatus 810 and/or apparatus 820 may be implemented in a network node, such as an AP in a WLAN.

In some implementations, each of apparatus 810 and apparatus 820 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 810 and apparatus 820 may be implemented in or as a STA or an AP. Each of apparatus 810 and apparatus 820 may include at least some of those components shown in FIG. 8 such as a processor 812 and a processor 822, respectively, for example. Each of apparatus 810 and apparatus 820 may further include one or more other components not pertinent to the proposed scheme of the present disclosure (e.g., internal power supply, display device and/or user interface device), and, thus, such component(s) of apparatus 810 and apparatus 820 are neither shown in FIG. 8 nor described below in the interest of simplicity and brevity.

In one aspect, each of processor 812 and processor 822 may be implemented in the form of one or more single-core processors, one or more multi-core processors, one or more RISC processors or one or more CISC processors. That is, even though a singular term “a processor” is used herein to refer to processor 812 and processor 822, each of processor 812 and processor 822 may include multiple processors in some implementations and a single processor in other implementations in accordance with the present disclosure. In another aspect, each of processor 812 and processor 822 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 812 and processor 822 is a special-purpose machine specifically designed for CMAP TF extension schemes in wireless communications in accordance with various implementations of the present disclosure.

In some implementations, apparatus 810 may also include a transceiver 816 coupled to processor 812. Transceiver 816 may include a transmitter capable of wirelessly transmitting and a receiver capable of wirelessly receiving data. In some implementations, apparatus 820 may also include a transceiver 826 coupled to processor 822. Transceiver 826 may include a transmitter capable of wirelessly transmitting and a receiver capable of wirelessly receiving data. It is noteworthy that, although transceiver 816 and transceiver 826 are illustrated as being external to and separate from processor 812 and processor 822, respectively, in some implementations, transceiver 816 may be an integral part of processor 812 as a system on chip (SoC), and transceiver 826 may be an integral part of processor 822 as a SoC.

In some implementations, apparatus 810 may further include a memory 814 coupled to processor 812 and capable of being accessed by processor 812 and storing data therein. In some implementations, apparatus 820 may further include a memory 824 coupled to processor 822 and capable of being accessed by processor 822 and storing data therein. Each of memory 814 and memory 824 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 814 and memory 824 may include a type of read-only memory (ROM) such as mask ROM, programmable ROM (PROM), erasable programmable ROM (EPROM) and/or electrically erasable programmable ROM (EEPROM). Alternatively, or additionally, each of memory 814 and memory 824 may include a type of non-volatile random-access memory (NVRAM) such as flash memory, solid-state memory, ferroelectric RAM (FeRAM), magnetoresistive RAM (MRAM) and/or phase-change memory.

Each of apparatus 810 and apparatus 820 may be a communication entity capable of communicating with each other using various proposed schemes in accordance with the present disclosure. For illustrative purposes and without limitation, a description of capabilities of apparatus 810, as STA 110, and apparatus 820, as STA 120, is provided below in the context of example processes 900 and 1000. It is noteworthy that, although a detailed description of capabilities, functionalities and/or technical features of one of apparatus 810 and apparatus 820 is provided below, the same may be applied to the other of apparatus 810 and apparatus 820 although a detailed description thereof is not provided solely in the interest of brevity. It is also noteworthy that, although the example implementations described below are provided in the context of WLAN, the same may be implemented in other types of networks.

### Illustrative Processes

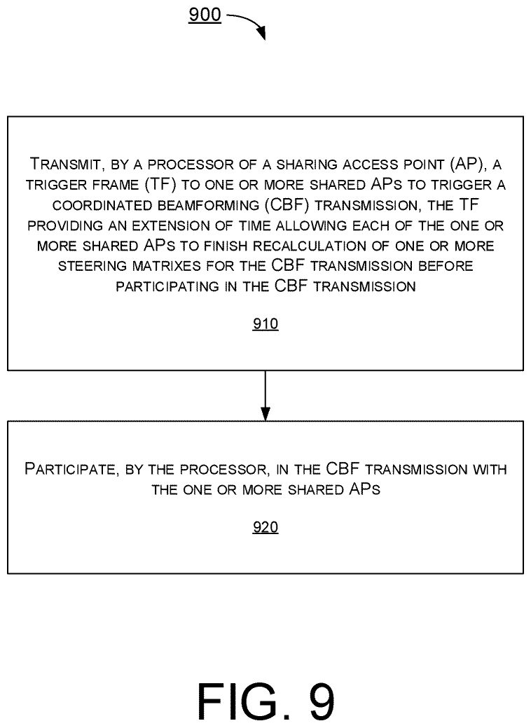

FIG. 9 illustrates an example process 900 in accordance with an implementation of the present disclosure. Process 900 may represent an aspect of implementing various proposed designs, concepts, schemes, systems and methods described above. More specifically, process 900 may represent an aspect of the proposed concepts and schemes pertaining to CMAP TF extension schemes in wireless communications in accordance with the present disclosure. Process 900 may include one or more operations, actions, or functions as illustrated by one or more of blocks 910 and 920. Although illustrated as discrete blocks, various blocks of process 900 may be divided into additional blocks, combined into fewer blocks, or eliminated, depending on the desired implementation. Moreover, the blocks/sub-blocks of process 900 may be executed in the order shown in FIG. 9 or, alternatively, in a different order. Furthermore, one or more of the blocks/sub-blocks of process 900 may be executed repeatedly or iteratively. Process 900 may be implemented by or in apparatus 810 and apparatus 820 as well as any variations thereof. Solely for illustrative purposes and without limiting the scope, process 900 is described below in the context of apparatus 810 implemented in or as AP0 (functioning as a sharing AP) and apparatus 820 implemented in or as AP1 or AP2 (functioning as a shared AP) of a wireless network such as a WLAN in network environment 100 in accordance with one or more of IEEE 802.11 standards. Process 900 may begin at block 910.

At 910, process 900 may involve processor 812 of apparatus 810 transmitting, via transceiver 816, a TF to one or more shared APs to trigger a CBF transmission. The TF may provide an extension of time allowing each of the one or more shared APs to finish recalculation of one or more steering matrixes for the CBF transmission before participating in the CBF transmission. Process 900 may proceed from 910 to 920.

At 920, process 900 may involve processor 812 participating, via transceiver 816, in the CBF transmission with the one or more shared APs.

In some implementations, the TF may include an existing TF specified under the IEEE 802.11ax specification with a definition of a subfield for trigger frame MAC padding duration expanded from non-AP STAs to cover APs. In some implementations, the subfield for trigger frame MAC padding duration may be expanded to 4 bits such that the duration for each of the one or more shared APs to perform matrix recalculation is extended up to 96 microseconds. In some implementations, the TF may be padded based on a largest minimum trigger processing time (MinTrigProcTime) of all shared APs of the one or more shared APs participating in the CBF transmission. In some implementations, the TF may be extended with extra symbols at an end of a packet of the TF. Moreover, the extra symbols may include either: (a) repetitions of LTF symbols used to decode data symbols, or (b) PE symbols.

In some implementations, the TF may include a CBF TF with a new subfield for CBF AP trigger frame MAC padding duration that indicates a minimum CBF AP trigger processing time (MinCBFAPTrigProcTime) which is used to pad the CBF TF. In some implementations, the subfield for CBF AP trigger frame MAC padding duration may have 4 bits such that the duration for each of the one or more shared APs to perform matrix recalculation is extended up to 96 microseconds. In some implementations, the CBF TF may be padded based on a largest MinCBFAPTrigProcTime of all shared APs of the one or more shared APs participating in the CBF transmission. In some implementations, the CBF TF may be extended with extra symbols at an end of a packet of the TF. Moreover, the extra symbols may include either: (a) repetitions of LTF symbols used to decode data symbols, or (b) PE symbols.

FIG. 10 illustrates an example process 1000 in accordance with an implementation of the present disclosure. Process 1000 may represent an aspect of implementing various proposed designs, concepts, schemes, systems and methods described above. More specifically, process 1000 may represent an aspect of the proposed concepts and schemes pertaining to CMAP TF extension schemes in wireless communications in accordance with the present disclosure. Process 1000 may include one or more operations, actions, or functions as illustrated by one or more of blocks 1010 and 1020. Although illustrated as discrete blocks, various blocks of process 1000 may be divided into additional blocks, combined into fewer blocks, or eliminated, depending on the desired implementation. Moreover, the blocks/sub-blocks of process 1000 may be executed in the order shown in FIG. 10 or, alternatively, in a different order. Furthermore, one or more of the blocks/sub-blocks of process 1000 may be executed repeatedly or iteratively. Process 1000 may be implemented by or in apparatus 810 and apparatus 820 as well as any variations thereof. Solely for illustrative purposes and without limiting the scope, process 1000 is described below in the context of apparatus 810 implemented in or as AP0 (functioning as a sharing AP) and apparatus 820 implemented in or as AP1 or AP2 (functioning as a shared AP) of a wireless network such as a WLAN in network environment 100 in accordance with one or more of IEEE 802.11 standards. Process 1000 may begin at block 1010.

At 1010, process 1000 may involve processor 822 of apparatus 820 receiving, via transceiver 826, a TF from a sharing AP that triggers a CBF transmission. The TF may provide an extension of time allowing the shared AP to finish recalculation of one or more steering matrixes for the CBF transmission before participating in the CBF transmission. Process 1000 may proceed from 1010 to 1020.

At 1020, process 1000 may involve processor 822 participating, via transceiver 826, in the CBF transmission with the sharing AP.

In some implementations, the TF may include an existing TF specified under the IEEE 802.11ax specification with a definition of a subfield for trigger frame MAC padding duration expanded from non-AP STAs to cover APs. In some implementations, the subfield for trigger frame MAC padding duration may be expanded to 4 bits such that the duration for the shared AP to perform matrix recalculation is extended up to 96 microseconds. In some implementations, the TF may be padded based on a largest minimum trigger processing time (MinTrigProcTime) of all shared APs, including the shared AP, participating in the CBF transmission. In some implementations, the TF may be extended with extra symbols at an end of a packet of the TF. Moreover, the extra symbols may include either: (a) repetitions of LTF symbols used to decode data symbols, or (b) PE symbols.

In some implementations, the TF may include a CBF TF with a new subfield for CBF AP trigger frame MAC padding duration that indicates a minimum CBF AP trigger processing time (MinCBFAPTrigProcTime) which is used to pad the CBF TF. In some implementations, the subfield for CBF AP trigger frame MAC padding duration may have 4 bits such that the duration for the shared AP to perform matrix recalculation is extended up to 96 microseconds. In some implementations, the CBF TF may be padded based on a largest MinCBFAPTrigProcTime of all shared APs, including the shared AP, participating in the CBF transmission. In some implementations, the CBF TF may be extended with extra symbols at an end of a packet of the TF. Moreover, the extra symbols may include either: (a) repetitions of LTF symbols used to decode data symbols, or (b) PE symbols.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
transmitting, by a processor of a sharing access point (AP), a trigger frame (TF) to one or more shared APs to trigger a coordinated beamforming (CBF) transmission; and
participating, by the processor, in the CBF transmission with the one or more shared APs,
wherein the TF provides an extension of time allowing each of the one or more shared APs to finish recalculation of one or more steering matrixes for the CBF transmission before participating in the CBF transmission.

2. The method of claim 1, wherein the TF comprises an existing TF specified under an Institute of Electrical and Electronics Engineers (IEEE) 802.11ax specification with a definition of a subfield for trigger frame medium access control (MAC) padding duration expanded from non-access point (non-AP) stations (STAs) to cover APs.

3. The method of claim 2, wherein the subfield for trigger frame MAC padding duration is expanded to 4 bits such that the duration for each of the one or more shared APs to perform matrix recalculation is extended up to 96 microseconds.

4. The method of claim 2, wherein the TF is padded based on a largest minimum trigger processing time (MinTrigProcTime) of all shared APs of the one or more shared APs participating in the CBF transmission.

5. The method of claim 2, wherein the TF is extended with extra symbols at an end of a packet of the TF, and wherein the extra symbols comprise:
repetitions of long-training field (LTF) symbols used to decode data symbols, or
packet extension (PE) symbols.

6. The method of claim 1, wherein the TF comprises a CBF TF with a new subfield for CBF AP trigger frame medium access control (MAC) padding duration that indicates a minimum CBF AP trigger processing time (MinCBFAPTrigProcTime) which is used to pad the CBF TF.

7. The method of claim 6, wherein the subfield for CBF AP trigger frame MAC padding duration has 4 bits such that the duration for each of the one or more shared APs to perform matrix recalculation is extended up to 96 microseconds.

8. The method of claim 6, wherein the CBF TF is padded based on a largest MinCBFAPTrigProcTime of all shared APs of the one or more shared APs participating in the CBF transmission.

9. The method of claim 6, wherein the CBF TF is extended with extra symbols at an end of a packet of the TF, and wherein the extra symbols comprise:
repetitions of long-training field (LTF) symbols used to decode data symbols, or
packet extension (PE) symbols.

10. A method, comprising:
receiving, by a processor of a shared access point (AP), a trigger frame (TF) from a sharing AP that triggers a coordinated beamforming (CBF) transmission; and
participating, by the processor, in the CBF transmission with the sharing AP,
wherein the TF provides an extension of time allowing the shared AP to finish recalculation of one or more steering matrixes for the CBF transmission before participating in the CBF transmission.

11. The method of claim 10, wherein the TF comprises an existing TF specified under an Institute of Electrical and Electronics Engineers (IEEE) 802.11ax specification with a definition of a subfield for trigger frame medium access control (MAC) padding duration expanded from non-access point (non-AP) stations (STAs) to cover APs.

12. The method of claim 11, wherein the subfield for trigger frame MAC padding duration is expanded to 4 bits such that the duration for the shared AP to perform matrix recalculation is extended up to 96 microseconds.

13. The method of claim 11, wherein the TF is padded based on a largest minimum trigger processing time (MinTrigProcTime) of all shared APs, including the shared AP, participating in the CBF transmission.

14. The method of claim 11, wherein the TF is extended with extra symbols at an end of a packet of the TF, and wherein the extra symbols comprise:
repetitions of long-training field (LTF) symbols used to decode data symbols, or
packet extension (PE) symbols.

15. The method of claim 10, wherein the TF comprises a CBF TF with a new subfield for CBF AP trigger frame medium access control (MAC) padding duration that indicates a minimum CBF AP trigger processing time (MinCBFAPTrigProcTime) which is used to pad the CBF TF.

16. The method of claim 15, wherein the subfield for CBF AP trigger frame MAC padding duration has 4 bits such that the duration for the shared AP to perform matrix recalculation is extended up to 96 microseconds.

17. The method of claim 15, wherein the CBF TF is padded based on a largest MinCBFAPTrigProcTime of all shared APs, including the shared AP, participating in the CBF transmission.

18. The method of claim 15, wherein the CBF TF is extended with extra symbols at an end of a packet of the TF, and wherein the extra symbols comprise:
repetitions of long-training field (LTF) symbols used to decode data symbols, or
packet extension (PE) symbols.

19. An apparatus, comprising:
a transceiver configured to communicate wirelessly; and
a processor coupled to the transceiver and configured to perform operations comprising:
transmitting or receiving, via the transceiver, a trigger frame (TF) that triggers a coordinated beamforming (CBF) transmission; and
participating, via the transceiver, in the CBF transmission,
wherein the TF provides an extension of time allowing each of one or more shared access points (APs) to finish recalculation of one or more steering matrixes for the CBF transmission before participating in the CBF transmission.

20. The apparatus of claim 19, wherein the TF comprises either:
an existing TF specified under an Institute of Electrical and Electronics Engineers (IEEE) 802.11ax specification with a definition of a subfield for trigger frame medium access control (MAC) padding duration expanded from non-access point (non-AP) stations (STAs) to cover APs; or
a CBF TF with a new subfield for CBF AP trigger frame MAC padding duration that indicates a minimum CBF AP trigger processing time (MinCBFAPTrigProcTime) which is used to pad the CBF TF.
